(19) United States
(12) Patent Application Publication
(10) Pub. No.: US 2011/0319027 A1
(43) Pub. Date: Dec. 29, 2011

(54) METHOD FOR CHANNEL QUALITY FEEDBACK IN WIRELESS COMMUNICATION SYSTEMS

(75) Inventors: Krishna Kamal Sayana, Arlington Heights, IL (US); Xiangyang Zhuang, Lake Zurich, IL (US)

(73) Assignee: MOTOROLA, INC., Schaumburg, IL (US)

(21) Appl. No.: 12/823,178

(22) Filed: Jun. 25, 2010

(51) Int. Cl. H04B 17/00

(52) U.S. Cl. 455/67.11

(57) ABSTRACT

A method for channel quality feedback in a wireless communication device that receives precoding information of at least one potentially co-scheduled wireless communication device that is potentially assigned a time frequency resource that is also assigned to the wireless communication device. The wireless communication device determines a channel quality metric based on the received precoding information and an assumption that the wireless communication device and the at least one potentially co-scheduled wireless communication device are assigned the same time frequency resource, and then feeds back the channel quality metric.

### FIELD OF THE DISCLOSURE

The present disclosure relates generally to wireless communications and, more particularly, to channel quality feedback in wireless communication systems.

### BACKGROUND

In wireless communication systems, closed-loop transmission techniques utilize knowledge of the channel response to weigh information transmitted from multiple antennas. To enable a transmit array to operate adaptively, a set of transmit weights is applied onto the signal before transmission from the antenna array where the transmit weights are derived from the channel response, channel statistics or characteristics, or a combination thereof. This operation is referred to as precoding, and closed loop precoding for single user (SU) schemes is enabled in the current 3GPP LTE Release-8 specification using feedback of an index to a preferred precoding matrix, i.e., a precoding matrix index (PMI), chosen from a set of predetermined precoding matrices (i.e., a precoding codebook). PMI may also include the information of the preferred spatial rank which represents the number of data streams the receiver can support for a particular channel. The operation is referred to as codebook based feedback.

Codebook-based feedback is favored due to low feedback overhead associated with a bit pattern representing the selected precoding matrix and the convenience of defining a feedback channel for conveying such a bit pattern. A receiver or user equipment (UE) determines the best codebook defined in the set. The transmitter or enhanced Node-B (eNB), after receiving the precoding matrix index, uses the corresponding precoding weights (matrix) for beamforming. If the suggested precoding matrix is used as recommended, the operation can be referred to as “codebook-constrained” beamforming or precoding.

In codebook based feedback, the receiver also feeds back the post-beamforming effective channel quality index (CQI) that is calculated based on the assumption that the reported PMI is applied at the transmitter. The CQI feedback is used by the transmitter to determine the modulation and coding scheme (MCS) level used for the subsequent data transmission. In essence, if the PMI recommended by the UE is adopted by the eNB, then a certain level of MCS, corresponding to the CQI, should be achieved at the UE. Therefore, in CQI reporting, the receiver typically should take into account any receiver impairments due to, for example, channel estimation, frequency offset, timing offset, etc. Often the CQI feedback is in the form of a MCS level associated with a target performance that is typically defined as a target frame or packet error probability at the recommended MCS level.

The next generation wireless communication specifications like 3GPP LTE-Advanced are expected to support advanced MIMO schemes like multiuser MIMO and Coordinated Multi-point (CoMP) MIMO transmission. Multiuser MIMO schemes allow simultaneous transmission to multiple users from the same frequency and time resources. Compared to single user schemes, the amount and accuracy of channel feedback information is critical to these advanced MU-MIMO operations. This is partly due to the fact that the transmitter should, by intelligent beamforming and user selection, mitigate any mutual interference between the multiple users to which the transmission occurs simultaneously using the same resources. Such intelligent transmission scheme requires good channel information to determine best user pairing and the precoding weights so that the eNB can deliver power more efficiently to each of the co-scheduled users while minimizing mutual interference between them. CoMP transmission further involves simultaneous transmission from multiple transmission points to one or more users. In the case of CoMP, the decision will further include transmission point selection.

In MU operation, an eNB determines the precoding parameters for all the users included in a simultaneous transmission, in addition to the selection of users (user selection is also referred to as user pairing for 2 UEs). Unlike the CQI derivation in SU precoding/beamforming, in MU transmission, a UE does not have any knowledge of potentially co-scheduled UEs' channels or their precoding parameters to effectively calculate the interference caused by the concurrent transmission. Hence the feedback of the accurate CQI under MU operation could be challenging. The present disclosure describes the methods to address reliable computation, feedback, and other related signaling aspects, of multi-user CQI (MU-CQI).

The various aspects, features and advantages of the invention will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates a wireless communication system with single user and multi-user transmissions.

FIG. 2 illustrates an example of a frame structure of an OFDM symbol, resource blocks and reference symbols.

FIG. 3A illustrates spatial precoding in single user transmission.

FIG. 3B illustrates spatial precoding in multiuser transmission.

FIG. 4 illustrates an exemplary implementation of CQI calculation at UE to support single-user precoding.

FIG. 5 illustrates an exemplary implementation of CQI calculation at UE to support multi-user precoding.

FIG. 6 illustrates an embodiment of the invention implemented at a wireless communication device.

FIG. 7 illustrates an embodiment of the invention implemented at a base station in a wireless communication system.

FIG. 8 illustrates eight-element antenna configuration using cross-polarization elements.

FIG. 9 illustrates a communication system with Co-ordinated Multi-point transmission with eNBs and two wireless communication devices.

### DETAILED DESCRIPTION

In the following description, the terms base-station, base unit, eNB, transmitter are used interchangeably to represent a point in a wireless that is transmitting data to another receiving device. The terms receiver, wireless device, UE, are used interchangeably to represent a device receiving data and communicating with a transmitting device.

In one implementation, the wireless communication system is compliant with the Third Generation Partnership Project (3GPP) Universal Mobile Telecommunications System (UMTS) Long Term Evolution protocol, also referred to as Evolved Universal Terrestrial Radio Access (EUTRA), or some future generation thereof, wherein the base unit transmits using an orthogonal frequency division multiplexing (OFDM) modulation scheme on the downlink and the user terminals transmit on the uplink using a single carrier frequency division multiple access (SC-FDMA) scheme. In another implementation, the wireless communication system is compliant with the IEEE 802.16 protocol or a future generation thereof. More generally, however, the wireless communication system may implement some other open or proprietary communication protocol where channel quality feedback is useful or desired. Thus the disclosure is not intended to be limited to or by the implementation of any particular wireless communication system architecture or protocol. The teachings herein are more generally applicable to any system or operation that utilizes multiple antennas in a transmission, whether the multiple antennas belong to a single base unit or to multiple base units or whether the multiple antennas are geographically co-located (e.g., belong to a single base unit) or distributed (belong to either remote radio heads or multiple cells).

As described above, in MU operation, an eNB determines the precoding parameters for all the users included in a simultaneous transmission, in addition to the selection of users (user selection is also referred to as user pairing for 2 UEs). Unlike the CQI derivation in SU precoding/beamforming, in MU transmission, a UE does not have knowledge of potentially co-scheduled UEs' channels or their precoding parameters, to effectively calculate the interference caused by the concurrent transmission. Hence the feedback of the accurate CQI under MU operation could be challenging.

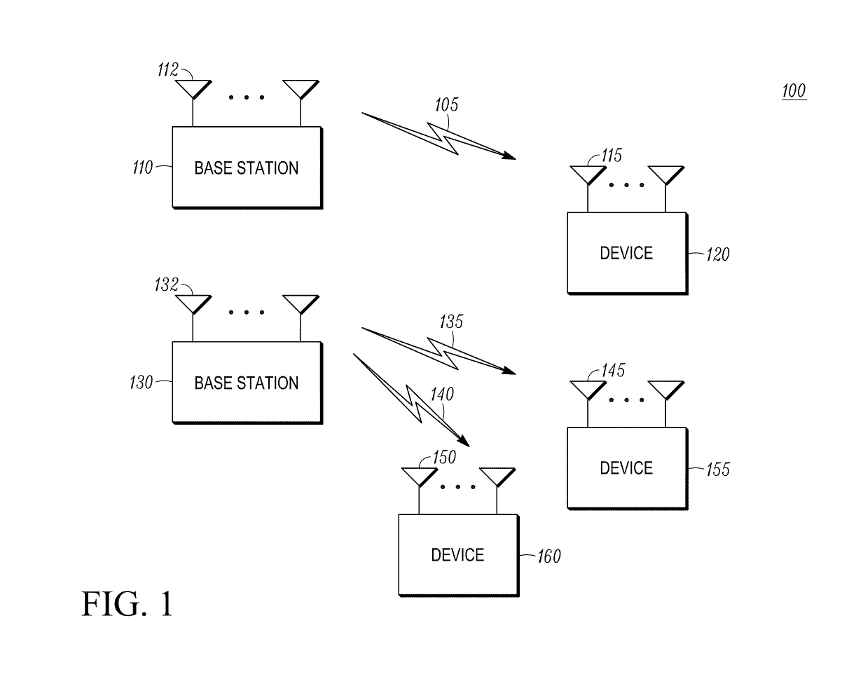

FIG. 1 illustrates single-user and multi-user transmission from a base station in a wireless communication system. In single-user transmission 105, a base station 110 transmits data to a single user 120 on a given time-frequency resource to be described later. In a multi-user transmission, a base station 130 transmits simultaneously (135, 140) on the same time-frequency resource to two users 155 and 160. More generally, multi-user transmission may be performed to more than two UEs.

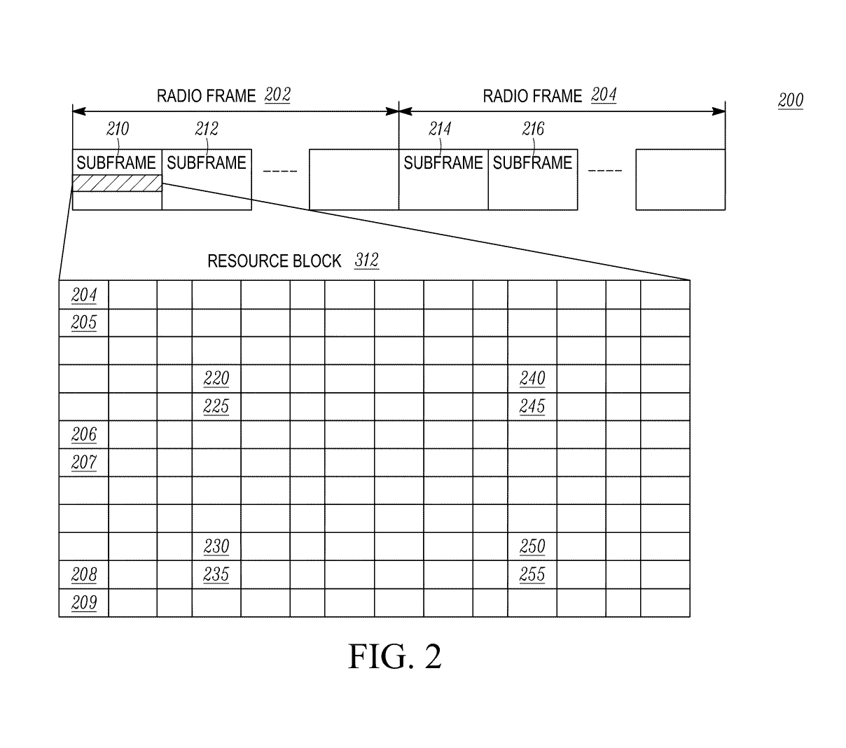

Time frequency resources are organized in an OFDM system according to a certain frame structure typically. FIG. 2 illustrates a frame structure used in the 3GPP LTE Release-8 (Rel-8). In typical OFDM based systems like 3GPP LTE, a block of consecutive OFDM symbols are referred to as a subframe. A subframe 210 in a radio frame 202 spans 14 OFDM symbols in time. Each sub-carrier location in each of the OFDM symbols is referred to as a resource element (RE), and a single data modulation symbol can be mapped to such a resource element on each spatial layer of transmission. A resource block (RB) is defined as a block of REs comprising a set of consecutive sub-carrier locations in frequency and a set of symbols. Further a subframe 210 contains multiple resource blocks 212, each spanning 12 consecutive subcarriers in frequency and a slot. In LTE Rel-8, a slot is defined to span 7 symbols and each subframe is made of two slots, and hence 14 symbols. A minimum resource unit allocated to a user is the two RBs corresponding to two slots in a subframe for a total of 2×12×7 REs. A resource block may also be more generally defined as a set of resource elements/OFDM subcarrier resources in the time and frequency domain in a typical OFDM air interface.

Some of the REs in a RB are reserved for reference symbols (RSs), which are also referred to as pilots, to help in the demodulation, and other REs are reserved for measurements at the UE. These reference symbols, as defined in LTE Release 8 can be further divided into two types. The first type is a cell-specific reference symbol (CRS), which is cell-specific and “common” to all users in a cell and is typically present in all the RBs. In FIG. 2, as an example only, RE 204, 205, 206, 207, 208 and 209 may be a CRS. CRSs are used for measurement and demodulation in 3GPP Release 8. The second type is a user-specific or a dedicated reference symbol (DRS), which is user-specific and hence applicable only to a particular user, and allocated in the RB's assigned to that particular user. DRS are used for demodulation only and may also be referred in some specifications as demodulation RS (DMRS). Furthermore, DRS typically correspond to “precoded” or beam-formed RSs, which can be directly used by a user for the demodulation of the data streams. The precoding operation is elaborated more later on. In FIG. 2, as an example only, RE 220, 225, 230, 235, 240, 245, 250 and 255 may be DRSs. In a general system that supports precoding transmission to a single user or to multiple users, pilots or reference symbols are sent from each antenna in a transmitter which enables a receiver to estimate channel state information (CSI). So in LTE Release-10, a new type of RS, namely CSI-RS is defined to enable channel measurements only, while DRS is primarily relied upon for demodulation. The CSI-RS can be used in a similar way as CRS in LTE Release-8 is used to derive channel feedback information. In general, CRS and CSI-RS are suitable for measuring an un-precoded channel, whereas the DRS are suitable for estimating the precoded channel.

In typical FDD operation of a LTE Rel-8 system, CRSs are also used for demodulation, and are sent over the whole bandwidth. If eNB employs a precoder at the transmitter, such precoding information is made known to the UE, which allows it to construct the precoded channel for demodulation purposes, based on the un-precoded channel measured on CRS and the knowledge of the precoder. As alluded to previously, another purpose of CRS is to enable closed loop feedback measurements. For example, by measuring the un-precoded channel, a UE may determine an optimal preferred PMI (Precoding Matrix Indicator). It may also perform CQI (Channel Quality Indicator) measurements. CQI in the description here will primarily refer to a Modulation and Coding Scheme (MCS) that can be used by the transmitter, along with other transmission parameters, to achieve a pre-defined target frame or packet error probability. For example, a UE can determine a supported CQI along with a preferred PMI and a preferred rank of transmission (Rank Indicator or RI). Note that when a codebook includes precoders for all possible ranks, the PMI information contains the RI information implicitly even without explicit feedback of RI. In general, un-precoded channel measurements may be used to compute various preferred transmission parameters corresponding to that UE.

The DRS correspond directly to the precoded channel and are typically embedded in the RBs allocated to a UE. It allows the eNB to flexibly choose any precoding parameters, different from the recommended PMI, without having to signal them to the UE. Certain measurements like CQI may also be measured directly on DRS. However, there are drawbacks since DRS correspond only to a particular set of time-frequency resources and a particular precoding. UE may not be able to obtain, from the DRS, the channel quality under a different PMI and RI. In a FDD operation of a future LTE Rel-10 system, CSI-RS may be primarily used for channel related measurements, while DRSs are mainly used for demodulation. CSI-RS are also transmitted across a whole bandwidth, similar to CRS, but more sparsely in time and frequency since they are not intended for demodulation. For example, they may be transmitted once every 10 subframes in time, and with a density as low as 1 RS per antenna port per RB when present in a subframe. The present description will primarily consider the case where the UE performs measurements for feedback based on CRS/CSI-RS and using un-precoded channel measurements.

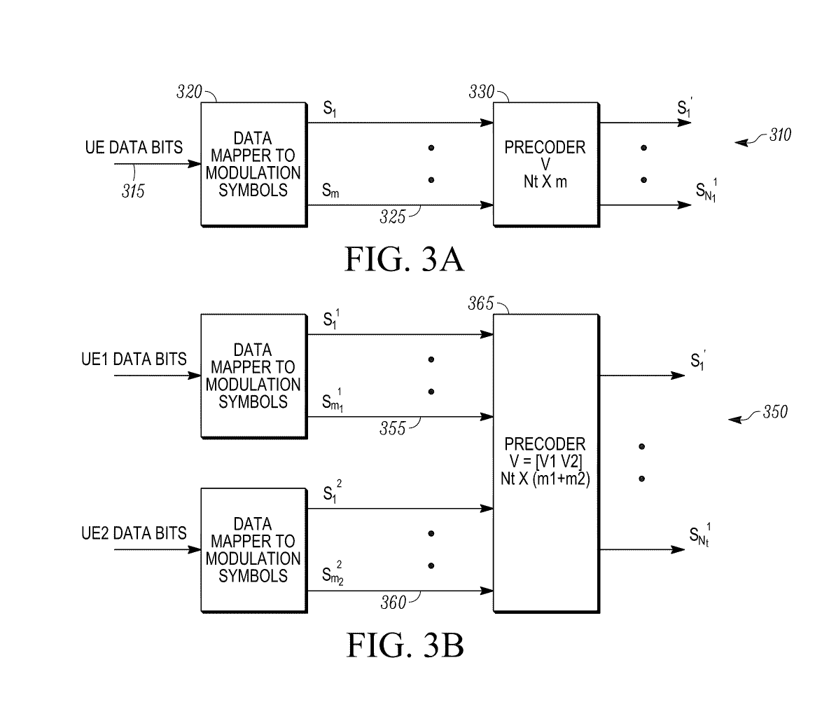

The “precoding” operation is explained in the following and illustrated in FIGS. 3a and 3b. For single user transmission, in FIG. 3A the base station maps a UE's data bits 315 to modulation symbols. The mapping may generally include coding (i.e., encode the data bits into one or more sets of coded bits called codewords), modulation (i.e., group coded bits in each codeword and map to QPSK/QAM symbols), and codeword to spatial stream mapping (i.e., map each codeword to one or more spatial streams). The modulation symbols of m spatial streams 325 are precoded with a precoder 330 to obtain complex symbols to be transmitted on individual antennas, with each stream having a corresponding precoding vector. The operation may be mathematically represented by the following matrix equation:

s′=Vs

in which, s is the vector of m transmitted symbols, V is the precoding matrix of dimension Nt×m and s′ is the resulting vector of Nt symbols transmitted on the Nt antennas. The received signal at the UE is represented as:

Y=HVs+n

in which, when transmitting one spatial layer of data, or rank-1, may be represented as:

$$[ \begin{matrix}{y}_{1} \\ ⋮ \\ {y}_{{N}_{R}}\end{matrix} ] = [ \begin{matrix}{h}_{1 , 1} & … & {h}_{1 , {N}_{T}} \\ ⋮ & ⋱ & ⋮ \\ {h}_{{N}_{R} , 1} & … & {h}_{{N}_{R} , {N}_{T}}\end{matrix} ] [ \begin{matrix}{v}_{1} \\ ⋮ \\ v \text{?}\end{matrix} ] \text{?} + n$$

$$\text{?} \text{indicates text missing or illegible when filed}$$

and in which, when transmitting two spatial layers of data, or rank-2, may be represented as:

$$[ \begin{matrix}{y}_{1} \\ ⋮ \\ y \text{?}\end{matrix} ] = [ \begin{matrix}{h}_{1 , 1} & … & {h}_{1 , {N}_{T}} \\ ⋮ & ⋱ & ⋮ \\ {h}_{{N}_{R} , 1} & … & {h}_{{N}_{R} , {N}_{T}}\end{matrix} ] [ \begin{matrix}{v}_{1 ,} \text{?} & {v}_{1 , 1} \\ ⋮ & ⋮ \\ {v}_{{N}_{T} , 1} & {v}_{{N}_{T} , 2}\end{matrix} ] [ \begin{matrix}\text{?} \\ \text{?} \text{?}\end{matrix} ] + n$$

$$\text{?} \text{indicates text missing or illegible when filed}$$

where y₁ . . . y_{N}_{_{R}} may be the received data at the UE receive antenna #1 to #NR, respectively. In the example with a rank-1 transmission, or a transmission with one data stream denoted as “s”, the precoding matrix V becomes a precoding vector with weights v_{1,1} . . . V_{N}_{_{T}}_{,1} corresponding to base station transmit antenna #1 to #NT, respectively. In an embodiment with a rank-2 transmission, or a transmission with two data streams denoted as s1 and s2, V may be a precoding matrix. Precoding vector and precoding matrix can be referred to as precoding matrix given vector is a degenerated case of matrix.

Matrix H of dimension Nr×Nt is the propagation channel matrix between transmit antennas and receive antennas with entry h1 representing a channel between the jth transmit and ith receive antennas. The vector n may represent noise and interference. The precoding weights V, either a vector or matrix, may be determined by the base station, typically based on the channel particular to the UE, or UE-specific, and the base station may also take into account a preference indicated by feedback from the UE. Further the matrix HV can be referred to as the effective or equivalent channel between a user's data streams and its receiver antennas. The effective channel, instead of the propagation channel H, is all that a UE needs for demodulation purposes and may be obtained from DRS or CRS. It may also be obtained from CSI-RS, but the accuracy may be too coarse for demodulation purpose, although still sufficient for deriving channel based feedback.

The precoder used at the eNB could be based on feedback of a preferred precoder from the UE, or based on channel measurements at a base station from the reverse link. For deriving such feedback, a UE may exhaustively search over all the precoder possibilities, constructing the corresponding effective channels and determining the performance associated with each precoder hypothesis. It would then select the best precoder and the associated parameters like CQI, RI and indicate them to the eNB. The CQI, PMI and RI are typically selected to satisfy a certain packet error probability. If eNB follows the UE's recommendation, it can expect to achieve the target performance. The UE recommendation may be used in advanced scheduling algorithms at the eNB to optimize the throughput of the system.

In FIG. 3B, a signal model with multiuser (MU) transmission at the eNB is illustrated with an example of two users being assigned the same time-frequency resources. Further as illustrated in FIG. 3B in the MU case, data bits of UE1 and UE2 are separately mapped to modulation symbols corresponding to m1 spatial streams 355 and m2 spatial streams 360, respectively.

Multiuser precoding is performed in 365, which may be represented in the mathematical data model as

s′=+V₁s¹+V₂s²

in which V1, V2 are precoders corresponding to UE 1 and UE 2 respectively and s1, s2 are symbol vectors corresponding to UE1 and UE2, respectively, of length m1 and m2. The received signal at UE i (i=1,2) may be represented as below, when transmitting a single layer (rank 1 transmission) to each UE (m1=m2=1),

$$\begin{matrix}[ \begin{matrix}{y}_{1} \\ ⋮ \\ ⋮ \\ {y}_{{N}_{R}}\end{matrix} ] = [ \begin{matrix}{h}_{11}^{1} & … & … & {h}_{1 , {N}_{T}}^{1} \\ ⋮ & ⋱ & ⋱ & ⋮ \\ ⋮ & ⋱ & ⋱ & ⋮ \\ {h}_{{N}_{R} , 1}^{1} & … & … & {h}_{{N}_{R} , {N}_{T}}^{1}\end{matrix} ] [ \begin{matrix}{v}_{1}^{1} \\ ⋮ \\ ⋮ \\ {v}_{{N}_{T}}^{1}\end{matrix} ] {s}_{1} + \\ [ \begin{matrix}{h}_{11}^{1} & … & … & {h}_{1 , {N}_{T}}^{1} \\ ⋮ & ⋱ & ⋱ & ⋮ \\ ⋮ & ⋱ & ⋱ & ⋮ \\ {h}_{{N}_{R} , 1}^{1} & … & … & {h}_{{N}_{R} , {N}_{T}}^{1}\end{matrix} ] [ \begin{matrix}{v}_{1}^{2} \\ ⋮ \\ ⋮ \\ {v}_{{N}_{T}}^{2}\end{matrix} ] {s}_{2} + n \\ = {H}^{1} {V}_{1} {s}_{1} + {H}^{1} {V}_{2} {s}_{2} + n\end{matrix}$$

in which, superscript represents user index and channel H¹ corresponds to channel at UE1.

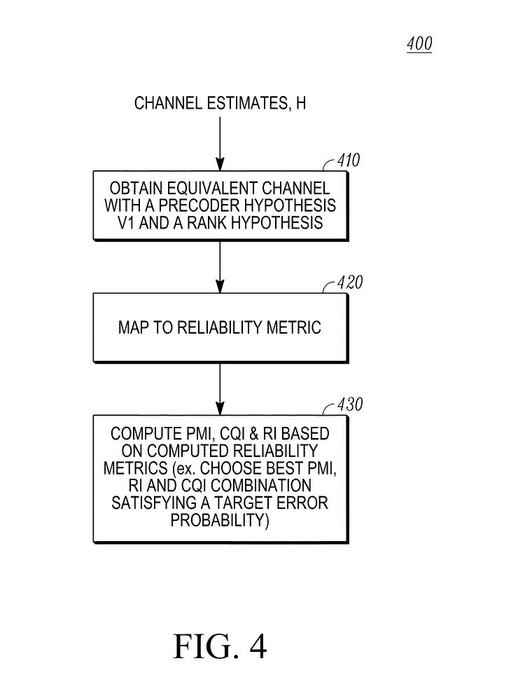

In a typical embodiment of UE feedback, a UE may always be required by the eNB to feedback parameters corresponding to single user transmission. In such a case, the UE may determine a precoder assuming single user transmission to UE1 as described before, along with the corresponding CQI and RI. We can refer to this CQI as single-user CQI or simply “SU-CQI”. A typical processing procedure for a UE to derive single-user PMI/RI and CQI is illustrated in FIG. 4. An equivalent channel is obtained in 410 corresponding to each precoder hypothesis as defined by the codebook, under the hypothesis of a certain transmission rank (which may be predefined by eNB or indicated to the UE). Reliability metrics are derived in 420 based on the equivalent channel for each hypothesis, while also taking into account UE receiver implementation. Examples of reliability metrics are effective SNR and some kind of rate/capacity metrics based on mutual information. In 430, a CQI, PMI and RI combination is determined that achieves a target error probability while maximizing a rate metric. These are generally well known in the art and are not limited to a particular implementation.

It must further be noted, in all references to CQI in the disclosure (like SU-CQI, MU-CQI etc), CQI may be comprised of more than one CQI corresponding to each spatial stream received by the UE (if such CQI is requested by the eNB and if rank>1) and the corresponding operations described, like averaging, apply to these per-stream CQIs. As a special case, a CQI is requested as the average CQI over the UEs spatial streams.

In one embodiment, if an eNB decides to perform multi-user transmission to two UEs, say UE1 and UE2, it uses two precoders V1 and V2, as described previously. For determining the transmission parameters like MCS for each UE with such transmission, eNB has a few options. It may determine the MCS/CQI corresponding to each UE based on some adjustment to the SU-CQIs fed back by the individual UEs.

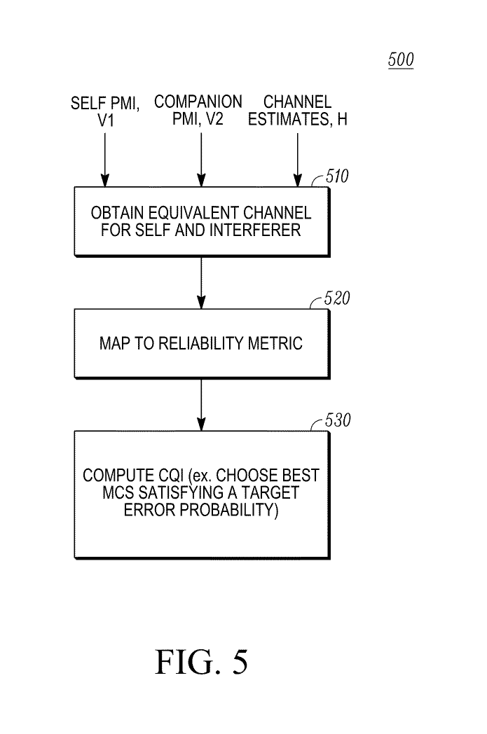

A MU-CQI may also be explicitly defined using a pre-defined computation method to be performed at the UE based on certain hypotheses. Since a UE has no knowledge of the precoder of the paired UE, it has to make some assumptions on that precoder. One possible assumption is to compute an average over all the possible pairings. For example let us denote the CQI of the UE1 in a multiuser transmission as CQI(V1,V2) if precoders V1 and V2 are used for UEs 1 and 2. Then one possible MU-CQI corresponding to a recommended precoder V1 may be obtained as the mean CQI averaged over all possible V2, i.e.:

$${CQI}_{MU , avg} ( {V}_{1} ) = \frac{1}{\vert \{ C \} \vert} {\sum }_{{v}_{2} ∈ \{ C \}}^{ } CQI ( {V}_{1} , {v}_{2} )$$

in which {C} is a pre-defined codebook of precoding vectors known to both eNB and the UE and |{C}| is the number of precoders in the codebook. A flow chart of the procedure for computing CQI(V1,v2) is further illustrated in FIG. 5. A UE obtains an equivalent channel based on “self” PMI V1, “companion” PMI v2, and the channel estimate H1 in 510. In 520, one or more reliability metrics are obtained based on the equivalent channel. The reliability metric(s) are further used to derive CQI/MCS in 530. We should also note the average CQI as defined above may be computed through several means and may not be a simple average. It could be a more general function of the CQIs or the reliability metrics. For example, the average operation could be used on the reliability metrics themselves instead of on CQI. Similar comments apply when average or other operation is defined on CQI.

As a variation of MU-CQI definition, the CQI may also be defined as the minimum (worst) or maximum (best) CQI as follows

$${CQI}_{MU , min} ( {V}_{1} ) = \frac{1}{\vert \{ C \} \vert} {min}_{{v}_{2} ∈ \{ C \}} CQI ( {V}_{1} , {v}_{2} )$$

$${CQI}_{MU , max} ( {V}_{1} ) = \frac{1}{\vert \{ C \} \vert} {max}_{{v}_{2} ∈ \{ C \}} CQI ( {V}_{1} , {v}_{2} )$$

In one embodiment, one or more of these three definitions of CQIs or a function of the three may be used. For example, the difference of two CQIs may be fed back in addition to one or more CQIs. Further, the corresponding paired precoder v2 that achieves the minimum/maximum CQI may also be fed back. More generally, a CQI or an MCS may be indicated on the feedback channel as an index from a discrete set of possibilities as currently defined in LTE Release-8 based on a 5-bit codebook. CQI difference may also be defined on a discrete set of values. For example, a delta CQI may be defined as a difference between two CQI indices.

However, there are some disadvantages to the above approaches of defining MU-CQI. Firstly, it would require a large number of computations by the UE. With a brute force approach, the number of CQI calculations is increased by an order of magnitude, since a UE computes a CQI value for each precoder pair (as opposed to each precoder only for SU-CQI). Some approximations may be used at the UE to reduce complexity, based on specific implementation. Secondly, the computed CQI may not correspond to the actual UE that an eNB decides to pair in the system. So, the reported CQI may be a mismatch to the CQI experienced in the actual transmission.

In an alternative embodiment, a simpler approach is proposed. An eNB indicates the paired precoder V2 to the UE1 by sending the V2 information to UE1, based on eNB scheduler's decision of a potential co-scheduled user (i.e., UE2). The “companion” precoder may be indicated to the target user device in the form of an index in the codebook (i.e., PMI) which could be the same codebook as that used for single-user MIMO. The UE1 then computes the MU-CQI based on the preferred precoder V1 derived for SU transmission and the received information of precoder V2.

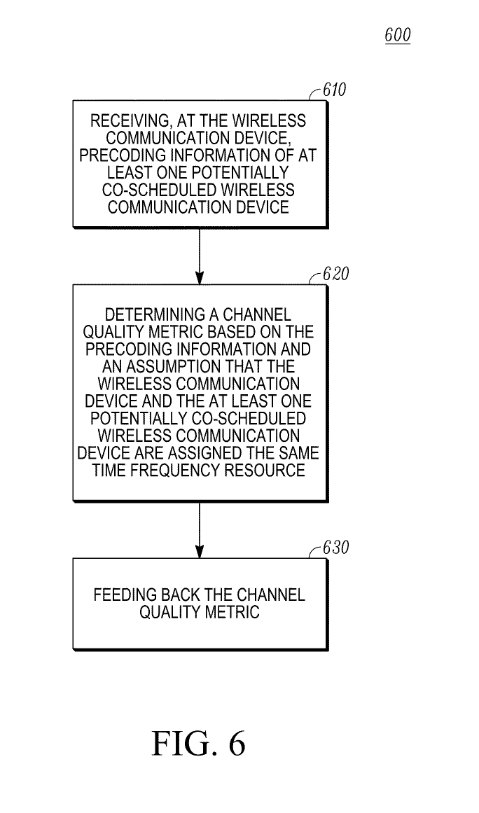

FIG. 6 illustrates the embodiment as including the acts of a wireless communication device receiving precoding information of at least one potentially co-scheduled wireless communications device as in 610, determining a channel quality metric based on the received precoding information and an assumption that the wireless communication device and the at least one potentially co-scheduled wireless communication device are assigned the same time frequency resources as in 620, and feeding back the channel quality metric.

A potentially co-scheduled wireless communication device is another wireless communication device in the system that is receiving transmissions from the base-station and the base-station considers as a suitable pairing device or “companion” to the wireless communication device. The precoding information corresponding to this companion device is indicated to the other UE. In our discussion, we may also refer to the precoding Information of at least one potentially co-scheduled wireless communications device as a “companion” PMI(s), and the precoding information assumption of the wireless communication device as “self” PMI for convenience of description.

In another variation of the embodiment described above, the UE1 may determine V1 conditioned on V2 as paired precoder, if requested to do so, as opposed to deriving V1 as the SU PMI assuming no pairing users.

Using SU PMI for self-PMI V1 in MU-CQI calculation may not accurately reflect the fact that actual precoding for UE1 in the case of MU could be different from the precoder used in the case of SU, because the precoder must be determined carefully at the eNB to not only maximize the received power at the target user, but also to minimize the mutual interference caused to other pairing users. In another variation of the above embodiments, precoder V1 is also sent from the eNB to UE1, for MU-CQI computation. The drawback of signaling both V1 and V2, as opposed to V2 only, is additional overhead.

In another embodiment, a wireless communication device may receive precoding information of a plurality of potentially scheduled wireless communication devices and determine a channel quality metric based on the assumption of at least a subset of the plurality of devices being co-scheduled as companions. For example precoding vectors V2, V3 may be signaled as the two co-scheduled companion UEs.

In a more general embodiment, a UE determines a first channel quality metric based on precoding information corresponding to at least a first sub-set of the plurality of potentially co-scheduled wireless communication devices and based on an assumption that the wireless communication device and the first sub-set of potentially co-scheduled wireless communication devices are assigned the same time frequency resource. The UE determines a second channel quality metric based on precoding information corresponding to at least a second sub-set of the plurality of potentially co-scheduled wireless communication devices and based on an assumption that the wireless communication device and the second sub-set of potentially co-scheduled wireless communication devices are assigned the same time frequency resource. Finally, the UE determines the channel quality metric based on at least the first channel quality metric or the second channel quality metric. In other words, a UE computes two or more channel quality metrics corresponding to different subsets of the companion PMIs and computes the final channel quality metric based on the two or more channel quality metrics. Such a determination could be to choose the best metric or worst metric or an average or some other combination thereof. Further, a UE may also indicate the corresponding subsets (for example by a predefined index) for the best or worst metrics. One special kind of the subset considered could also be a null set, i.e., ‘no MU transmission’ or single user transmission only.

In one embodiment, a set of matrices could be predefined in a codebook to be known at the eNB and the UE to represent companion PMI V2. The matrices in the codebook may all have the same or different ranks. For example, some matrices could be of size Ntx1 and others Ntx2 and so on. In a realization of embodiment in FIG. 6, an eNB may indicate an index from such codebook and a UE may obtain CQI as described above. An eNB may also indicate a plurality of companion PMIs from such a codebook. A UE may feed back multiple CQIs corresponding to a subset of such PMIs. In one example, an eNB may indicate two companion PMIs, one for rank 1 and one for rank 2 and a UE feeds back two CQIs corresponding to each companion PMI. In a further simplification, a companion PMI for one rank may be implicitly determined by that of a higher rank and the UE feeds back a CQI for each rank. As an example, PMI for rank 1 is a single column of PMI for rank 2.

In the embodiments described above, an eNB may additionally indicate a preferred rank for the UE precoder itself. For example if eNB indicates rank 1 as a preferred rank, a UE should determine V1 limiting to the rank 1 codebook for the purpose of computing MU-CQI.

The signaling of the companion PMI by the base station requires control signaling bits on the downlink. Control overhead minimization is one consideration in system optimization. Hence V2 may be indicated to the UE less frequently or with less accuracy than that of V1. Less frequent/less accurate V2 indication may be sufficient, since typically beam-steering or precoding to multiple users is based on their long term locations (especially with correlated Uniform Linear Array (ULA) type antenna arrays at the eNB) and the precoder changes only semi-statically in time. As an example of less frequent/less accurate V2 indication for computing MU-CQI, a UE may determine self PMI V1 for each sub-band. A subband is a set of contiguous subcarriers, which encompass a subset of the whole bandwidth used for transmission at the eNB. However, the V2 indicated could correspond to the whole bandwidth. More generally any SU-CQI computation corresponding to a subband can have a corresponding MU-CQI computed using the indicated V2 (which is indicated infrequently as a single index for the whole band) and the self PMI V1 corresponding to that subband. Further, MU-CQI may be indicated as a difference or a delta-CQI relative to the SU-CQI, where the delta-CQI could be defined as the difference in the MCS index as described before.

As an exemplary implementation of the above embodiment, eNB indicates V2 on a long-term basis, a UE determines SU-CQI(b) and corresponding V1(b) for each subband b, MU-CQI(b) corresponding to each subband b based on V1(b) and V2. It may further determine an average of SU-CQI and MU-CQI over a set of two or more sub-bands or the whole bandwidth and determine their difference. MU-CQI is represented as a difference from SU-CQI in this case. The difference CQI is fed back in addition to SU-CQI. This approach helps reduce the additional feedback for multi-user transmission compared to existing single-user feedback modes defined in the current specifications and may be of sufficient accuracy for eNB scheduling purposes.

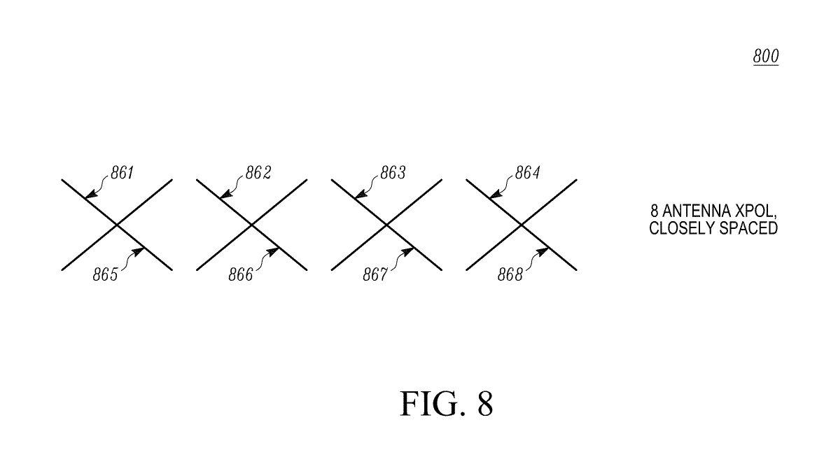

In systems with large number of antennas, due to space limitations in deployment, a combination of ULA and cross-pole elements are used to achieve good trade-off between beamforming and spatial multiplexing (high rank) transmissions. For example, for an eight transmit antenna deployment at the base station, an 8×2 cross-pole configuration may be used. A cross-polarized configuration with four sets of cross-poles each with two antennas at +/−45 polarizations is illustrated in FIG. 8. The long-term beamforming can be performed using a channel corresponding to ULA subgroups of antennas (861-864 and 865-868).

In such deployment of cross-pole antennas (but not limited to such configurations), feedback based on tracking the two components of the channel may be defined. Such a feedback scheme may in general use different rates of feedback for each component and reduce overall feedback overhead. As a preferred example, a two component codebook based on two codebooks may be defined. For example, a final precoder may be defined as a function of two component precoders as follows V=f (Wₗ,Wₛ). Typically, the function could be a simple matrix product like WₗWₛ or WₛWₗ or a Kronecker tensor product Wₗ [symbol] Wₛ or Wₛ [symbol] Wₗ or a similar product. More importantly, one matrix Wₗ tracks the long-term properties of the channel and Wₛ tracks short-term properties of the channel. For simple single user precoding feedback, a UE may feed back Wₗ on a long-term and/or wideband basis and Wₛ on short-term/subband basis. Since, as described above to minimize the control signaling overhead on the downlink, an eNB should preferably indicate the companion PMI on a long-term basis. The development for MU-CQI can be applied to such two component feedback schemes by eNB signaling Wₗ₂ in place of V2, where Wₗ₂ denotes only the long-team related component corresponding to UE2. The development applies with two modifications. Since Wₛ₂ is not signaled, a UE must be able to assume a predefined rule to obtain V2 from Wₗ₂. A simple rule is to pre-define i) a fixed value, or ii) a fixed set of values to average over or to combine, or to leave it to UE implementation for determining Wₛ₂. The rest of the development in the previous embodiments can be applied defining V₂=f (Wₗ₂,Wₛ₂) where Wₛ₂ is defined as described. In this case, only the first codebook corresponding to the Wₗ may be indicated by the eNB as a partial (but most relevant) information of companion PMI.

The MU CQI computation described here and illustrated in FIG. 5 is based on hypothesis of V1 and V2 as precoders at the transmitter. As another embodiment, a pre-defined transformation known to eNB and UE may be used to map V1 and V2 to F1 and F2 and then obtain CQI based on F1 and F2 for precoding hypothesis. It is represented below mathematically,

CQI_{T}(V1,v2)=CQI(T(V1,v2))

One example of the transformation is Zero-forcing precoding defined as below,

[F₁F₂]=T(V₁,V₂)=U^{H}(UU^{H}αI)⁻¹, U^{H}=[V₁V₂]

in which α is a regularization factor and I is an identity matrix.

In another embodiment, a power offset could be indicated to the UE along with a companion PMI. For example, the power offset could be the offset of the total power allocated to the companion PMI as opposed to that of the UE's self PMI. In this case, for CQI computation at UE should assume a precoder of the form

$$\frac{1}{( 1 + ρ )} [ {cV}_{1} ρ {cV}_{2} ]$$

Where ‘c’ is a common scaling factor which may already be assumed for the power normalization at the transmitter (which was omitted in our description before for convenience) and ρ is the power offset used for the companion PMI with respect to the UE's PMI. More generally, more than one offset may be defined for each rank of companion PMI and/or self PMI and a representation of these offsets may be separately signaled to the UE in addition to a companion PMI or implicitly as a joint index in a larger codebook to signal both the companion PMI and the offset.

In various embodiments described herein, the eNB indicates to the UE precoding information related to the other UE for aiding the more accurate CQI computation at the UE with multiuser transmission. It must be noted that precoding information corresponding to a UE also serves as a coarse approximation of that UE's channel. More specifically, it may be viewed as a reduced rank approximation of the channel covariance matrix without the eigen value information, since a PMI is a coarse approximation of SVD of a channel covariance matrix.

In a future implementation of a wireless communication system, a UE may feed back more accurate channel information to the eNB, for example, a channel covariance matrix or the channel matrix itself. We can refer to this more generally as channel state information, which includes PMI as a special case as described. In a generalization of the various embodiments described herein, an eNB may indicate the channel information of the potentially co-scheduled device to the wireless communication device. In such a case, a UE may determine precoding vectors for self (V1) and the companion (V2) and an optional power offset based on the measured/estimated channel information of self and the signaled channel information of other UE and further compute CQI as described in various embodiments before. An example of such channel information and corresponding transformation could be the combined channel matrix H derived from H1 and H2 and the zero-forcing precoding approach. Other linear or non-linear transformations may also be used to derive the precoding and the corresponding power offsets, which would enable UE to derive the CQI. Further, with more refined channel state of both UEs, a UE may also be able to derive one or more of the other transmission parameters like RI and recommendation for self and companion PMIs, which could be feedback to the eNB.

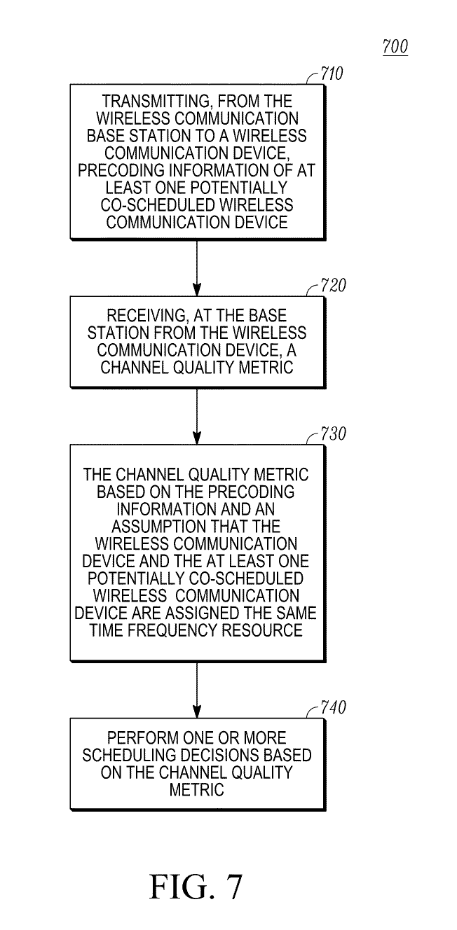

An illustration of the embodiments described herein as implemented in a transmitter is provided in FIG. 7. At 710, the wireless communication base station transmits, to a wireless communication device, precoding information of at least one potentially co-scheduled wireless communication device. At 720, the base station receives from the wireless communication device, a channel quality metric wherein the channel quality metric is based on the precoding information and an assumption that the wireless communication device and the at least one potentially co-scheduled wireless communication device are assigned the same time frequency resource as in 730. At 740, one or more scheduling decisions are performed based on the channel quality metric. The scheduling decisions may include user selection, pairing, allocation of total time-frequency resources, assigning MCS and other transmission parameters like precoding and MIMO transmission mode switching (between single user and multi-user modes and different ranks of transmission for self and/or companion PMIs).

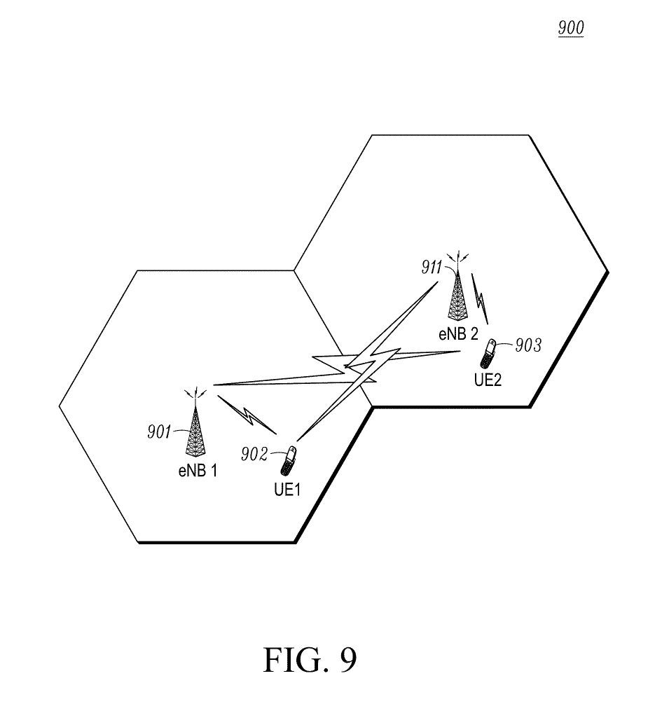

The various embodiments described herein may also be applied to Coordinated Multipoint transmission (CoMP). Similar to multi-user MIMO, a network including one or more eNBs determines transmission parameters based on channel feedback from more than one UE and UE benefits from assistance/indication of the parameters for better CQI estimation. In FIG. 9, a wireless communication system 900 performing CoMP transmission is illustrated, which comprises two base infrastructure units/eNBs 910 and 911 serving remote units 902 and 903 simultaneously. The base units may communicate and exchange information regarding scheduling, precoding and so oh. Further a UE 902 may have an associated serving cell/base unit 910, with which it primarily exchanges control information. Further a UE 902 may also be aware of the potential CoMP transmission set which could include one or more base units 911 and be able to measure the channel from one or more base units 911 based on the CRS/CSI-RS transmitted from 911. The UE 902 may be made aware of the RS locations/sequence and other information which enable it to perform these measurements.

The following mathematical model represents the signal received at the UE1 when two eNBs eNB1 and eNB2 are performing CoMP transmission to two UEs, UE1 and UE2.

$$[ \begin{matrix}{y}_{1} \\ ⋮ \\ ⋮ \\ {y}_{{N}_{R}}\end{matrix} ] = [ \begin{matrix}{h}_{11}^{1} & … & {h}_{1 , {N}_{T}}^{1} & {g}_{11}^{1} & … & {g}_{1 , {N}_{T}}^{1} \\ ⋮ & ⋮ & ⋮ & ⋮ & ⋮ & ⋮ \\ ⋮ & ⋮ & ⋮ & ⋮ & ⋮ & ⋮ \\ {h}_{{N}_{R} , 1}^{1} & … & {h}_{{N}_{R} , {N}_{T}}^{1} & {g}_{{N}_{R} , 1}^{1} & … & {g}_{{N}_{R} , {N}_{T}}^{1}\end{matrix} ] [ \begin{matrix}{v}_{1}^{1} \\ ⋮ \\ {v}_{{N}_{T}}^{1} \\ {u}_{1}^{1} \\ ⋮ \\ {u}_{{N}_{T}}^{1}\end{matrix} ] {s}_{1} + [ \begin{matrix}{h}_{11}^{1} & … & {h}_{1 , {N}_{T}}^{1} & {g}_{11}^{1} & … & {g}_{1 , {N}_{T}}^{1} \\ ⋮ & ⋮ & ⋮ & ⋮ & ⋮ & ⋮ \\ ⋮ & ⋮ & ⋮ & ⋮ & ⋮ & ⋮ \\ {h}_{{N}_{R} , 1}^{1} & … & {h}_{{N}_{R} , {N}_{T}}^{1} & {g}_{{N}_{R} , 1}^{1} & … & { }_{{N}_{R} , {N}_{T}}^{1}\end{matrix} ] [ \begin{matrix}{v}_{1}^{2} \\ ⋮ \\ {v}_{{N}_{T}}^{2} \\ {u}_{1}^{2} \\ ⋮ \\ {u}_{{N}_{T}}^{2}\end{matrix} ] {s}_{2} + n = [ {H}^{1} {G}^{1} ] [ \begin{matrix}{V}_{1} \\ {U}_{1}\end{matrix} ] {s}_{1} + [ {H}^{1} {G}^{1} ] [ \begin{matrix}{V}_{2} \\ {U}_{2}\end{matrix} ] {s}_{2} + n$$

in which, H¹ represents channel received at the UE1 from eNB1 and G′ represents the channel at the UE1 from eNB2. V1, V2 represent precoders applied at the eNB1 for UE1 and UE2 respectively. Similarly U1, U2 represent precoders applied at eNB2 for UE1 and UE2 respectively. Note that in general, the eNBs may have different number of transmit antennas Nt, and more than two eNBs or two UEs may participate in such CoMP transmission.

The above model represents a general CoMP scheme that can be referred to as joint processing multiuser CoMP transmission where both eNBs transmit simultaneously two UEs. One special case is the joint processing single-user CoMP transmission where both eNB1 and eNB2 transmit to UE1 only (V2=U2=0). Another case is coordinated beamforming, where eNBs target individual UEs, while avoiding interference to other UEs, i.e., eNB1 targets UE1 and eNB2 targets UE2 (U1=V2=0).

The embodiments described before for MU-CQI can be applied to CoMP-CQI calculation. In this case, eNB may signal one or more of the precoders (V1,V2,U1,U2) along with the index of coordinating eNBs, which allows a UE1 which has eNB1 as its serving cell to make channel measurements (“G1” in the above equation) corresponding to the coordinating eNB. A UE may also compute one or more of the precoders, which are used along with indicated precoders to compute CoMP CQI at the UE.

In one embodiment with coordinated beamforming (U1=V2=0) an eNB1 indicates to UE1, the precoder U2 that may be potentially used by eNB2 to transmit data to a potential co-scheduled CoMP UE2. The UE computes CQI in a similar manner to MU-CQI, either by calculating V1 based on some transmission hypothesis like SU transmission or similar and using indicated U2 along with measured channels from both eNBs to obtain equivalent channels. In one embodiment, a UE may also indicate a preference for a particular CoMP scheme/mode, based on one or more potential precoders indicated by the eNB.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method for channel quality feedback in a wireless communication device, the method comprising:
receiving, at the wireless communication device, precoding information of at least one potentially co-scheduled wireless communication device,
the potentially co-scheduled wireless communication device is a device that is potentially assigned a same time frequency resource as assigned to the wireless communication device;
determining a channel quality metric based on the received precoding information and an assumption that the wireless communication device and the at least one potentially co-scheduled wireless communication device are assigned the same time frequency resource,
feeding back the channel quality metric.

2. The method of claim 1 further comprising:
receiving precoding information for a plurality of potentially co-scheduled wireless communication devices,
determining the channel quality metric based on precoding information corresponding to at least a sub-set of the plurality of potentially co-scheduled wireless communication devices and based on an assumption that the wireless communication device and the sub-set of potentially co-scheduled wireless communication devices are assigned the same time frequency resource.

3. The method of claim 2 further comprising:
determining a first channel quality metric based on precoding information corresponding to at least a first sub-set of the plurality of potentially co-scheduled wireless communication devices and based on an assumption that the wireless communication device and the first sub-set of potentially co-scheduled wireless communication devices are assigned the same time frequency resource,
determining a second channel quality metric based on precoding information corresponding to at least a second sub-set of the plurality of potentially co-scheduled wireless communication devices and based on an assumption that the wireless communication device and the second sub-set of potentially co-scheduled wireless communication devices are assigned the same time frequency resource,
determining the channel quality metric based on at least the first channel quality metric or the second channel quality metric.

4. The method of claim 3, wherein determining the channel quality metric includes selecting at least the first channel quality metric or the second channel quality metric, and feeding back the channel quality metric includes feeding back information identifying the subset corresponding to the selection.

5. The method of claim 1, wherein determining the channel quality metric is based further on precoding information of the wireless communication device, the precoding information of the wireless communication device is derived at the wireless communication device based on an assumption that no other wireless communication device is assigned the same time frequency resource as the wireless communication device.

6. The method of claim 1, wherein determining the channel quality metric based further on received precoding information of the wireless communication device.

7. The method of claim 1,
determining the channel quality metric based further on precoding information of the wireless communication device wherein the precoding information of the wireless communication device corresponds to at least one sub-band of a system bandwidth, and
the precoding information of the at least one potentially co-scheduled wireless communication device corresponds to the system bandwidth.

8. The method of claim 1, receiving the precoding information of the at least one potentially co-scheduled wireless communication device includes receiving a component of the precoding information of the at least one potentially co-scheduled wireless communication device, wherein the pre-coding information of the at least one potentially co-scheduled wireless communication device includes at least two components.

9. The method of claim 1 further comprising:
determining a first channel quality metric based on precoding information corresponding to the at least one potentially co-scheduled wireless communication device and based on an assumption that the wireless communication device and the at least one potentially co-scheduled wireless communication device are assigned the same time frequency resource,
determining a second channel quality metric based on an assumption that no other wireless communication device is assigned the same time frequency resource as the wireless communication device,
determining the channel quality metric based on at least the first channel quality metric or the second channel quality metric.

10. The method of claim 9 determining the channel quality metric includes selecting either the first channel quality metric or the second channel quality metric, and feeding back the channel quality metric includes feeding back information identifying the selection.

11. The method of claim 10 determining the channel quality metric includes selecting either the first channel quality metric or the second channel quality metric.

12. A method for channel quality feedback in a wireless communication base station, the method comprising:
transmitting, from the wireless communication base station to a wireless communication device, precoding information of at least one potentially co-scheduled wireless communication device,
the potentially co-scheduled wireless communication device is a device that is potentially assigned a same time frequency resource as assigned to the wireless communication device;
receiving, at the base station from the wireless communication device, a channel quality metric,
the channel quality metric based on the precoding information and an assumption that the wireless communication device and the at least one potentially co-scheduled wireless communication device are assigned the same time frequency resource.

13. The method of claim 12 further comprising assigning the same time frequency resource to the wireless communication device and to the potentially co-scheduled wireless communication device based on the channel quality metric.

14. The method of claim 12 further comprising not assigning the same time frequency resource to the wireless communication device and to any other wireless communication device based on the channel quality metric.

15. The method of claim 12,
the channel quality metric based further on precoding information of the wireless communication device wherein the precoding information of the wireless communication device corresponds to at least one sub-band of a system bandwidth, and
the precoding information of the at least one potentially co-scheduled wireless communication device corresponds to the system bandwidth.

16. The method of claim 12, transmitting the precoding information of the at least one potentially co-scheduled wireless communication device includes transmitting a portion of the precoding information of the at least one potentially co-scheduled wireless communication device.

17. The method of claim 12, wherein receiving the channel quality metric includes receiving feeding back information identifying a selection of either a first channel quality metric or a second channel quality metric by the wireless communication device.

18. The method of claim 12, wherein receiving the channel quality metric includes receiving feeding back information identifying a subset of at least one potentially co-scheduled wireless communication device corresponding to a selection of at least a first channel quality metric or a second channel quality metric by the wireless communication device.
